(19) United States
(12) Patent Application Publication
(10) Pub. No.: US 2024/0103785 A1
(43) Pub. Date: Mar. 28, 2024

(54) PRINTING SYSTEM, PRINTING METHOD, AND NON-TRANSITORY RECORDING MEDIUM

(71) Applicant: KONICA MINOLTA, INC., Tokyo (JP)

(72) Inventor: Taro YAMAMOTO, Toyohashi-shi (JP)

(21) Appl. No.: 18/475,389

(22) Filed: Sep. 27, 2023

(30) Foreign Application Priority Data
Sep. 28, 2022 (JP) 2022-155219

(51) Int. Cl. G06F 3/12

(52) U.S. Cl. CPC G06F 3/1239; G06F 3/121

(57) ABSTRACT

A printing system includes a hardware processor that: acquires a restriction to be applied in a case where a user uses a first printer; acquires a print condition in a case where the user uses a second printer; determines whether the print condition infringes on the restriction; and notifies the user of a determination result.

### CROSS-REFERENCE TO RELATED APPLICATION

The present invention claims priority under 35 U.S.C. § 119 Japanese Patent Application No. 2022-155219 filed on Sep. 28, 2022, including description, claims, drawings, and abstract, is incorporated herein by reference in its entirety.

### BACKGROUND

### 1. Technological Field

The present invention relates to a printing system, a printing method, and a non-transitory recording medium that allows a user who intends to produce a printout using, for example, his/her own printer that is not covered by restrictions as to the printable number of sheets, functions, and the like on, for example, a printer in an office, to recognize whether the print condition infringes on the restrictions.

### 2. Description of the Related Art

In recent years, a way of working called “work from home (WFH)” has become widespread. In many cases, a person who works from home uses a company-owned personal computer (PC) and his/her own printer placed in his/her home.

A company manages and bears the costs of paper, toner, and the like to be consumed using a printer in an office. At home, an individual purchases a printer on the assumption of personal use, and therefore generally pays for consumed paper, ink, and the like. As a result, when an individual uses his/her own printer for business use at home, he/she needs to bear the costs of paper, ink, and the like.

In view of this, it is conceivable to separately charge a company for the cost of printing at home, which may however result in the following problem.

In an office, typically, the usage of a printer is managed by a print management system. This is because a certain rule is applied by implementing, for each user or group using the printer, print management involving restrictions as to the printable number of sheets, functions (e.g., color printing, double-sided printing), and the like.

For use of the printer, the user needs to log in to the print management system and fails to execute a print job that violates the restrictions as to the printable number of sheets, the functions, and the like.

At home, however, it is impossible for the user to recognize the restrictions on the printer in the office. Consequently, the user produces printouts irrespective of the restrictions as to the printable number of sheets, the functions, and the like. In this case, even when the user charges his/her company for the cost of printing at home, the company rejects the charge since the print job violates the restrictions, making the printouts wasteful in some cases.

Japanese Unexamined Patent Application Publication No. 2018-207344 discloses the following technique. That is, an image forming apparatus requests a business document determination system to determine whether a document to be printed is for business use, in response to a print instruction from a user. The business document determination system determines whether the document is for business use, based on a template, images, and words. In a case where the document is for business use, the business document determination system bills a company for the cost of printing. In a case where the document is for private use, a warning displayed on a display unit causes the user to selectively instruct whether the document is for business use or private use. In a case where the document is for business use, and the user selectively instructs that the document is for business use, the relevant page is stored in a document storage server, and a notification is provided to a manager terminal.

Japanese Unexamined Patent Application Publication No. 2005-111948 discloses that a function identifying module identifies a designated one of a plurality of functions of an image forming apparatus, under the control by a control module. In a case where the designated function is a “Photo Print” function, an individual identifying module identifies a personal ID, and a business use/private use category identifying module identifies a business use/private use category. A time zone determination module determines a time zone, and an image read module reads image data in accordance with a determination result. An image formation instructing module issues an instruction to form an image based on the image data. A history recording module records an image formation history. A billing module bills an individual in a case where an image forming operation is for private use and bills a department in other cases.

According to the techniques disclosed in the foregoing two publications, it is possible to determine whether a printing operation is for business use. However, the foregoing two publications do not disclose that if an individual causes, for example, his/her own printer which is not subjected to cost management to execute a print job for business use, settlement of the cost of printing is permittable. Consequently, the foregoing publications provide none of solutions to the foregoing problem. That is, it is impossible for a user who intends to produce a printout at home to recognize restrictions on a printer in an office. As a result, a company rejects settlement of the cost of printing based on a print job violating the restrictions, making the printout wasteful.

### SUMMARY

An object of the present invention is to provide a printing system, a printing method, and a non-transitory recording medium that allow a user to recognize whether a print condition in a case where the user uses, for example, his/her own printer for the purpose of, for example, WFH infringes on restrictions as to the printable number of sheets, functions, and the like on, for example, a printer in an office.

A first aspect of the present invention relates to
a printing system including
a hardware processor that:
acquires a restriction to be applied in a case where a user uses a first printer;
acquires a print condition in a case where the user uses a second printer;
determines whether the print condition infringes on the restriction; and
notifies the user of a determination result.

A second aspect of the present invention relates to
a printing method including:
acquiring a restriction to be applied in a case where a user uses a first printer;
acquiring a print condition in a case where the user uses a second printer;
determining whether the print condition infringes on the restriction; and
notifying the user of a determination result.

A third aspect of the present invention relates to
a non-transitory recording medium storing a computer readable program that causes a computer to execute:
acquiring a restriction to be applied in a case where a user uses a first printer;
acquiring a print condition in a case where the user uses a second printer;
determining whether the print condition infringes on the restriction; and
notifying the user of a determination result.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating a configuration of a printing system according to an exemplary embodiment of the present invention.

FIG. 2 is a block diagram illustrating a configuration of a terminal apparatus and a configuration of a multi-function peripheral (MFP) management system.

FIG. 3 is a sequence diagram illustrating operations of the printing system illustrated in FIG. 1.

FIG. 4 is a diagram illustrating an exemplary screen for notifying a user of a result of a determination whether a print condition for a second printer infringes on a restriction on a first printer.

FIG. 5 is an exemplary table for managing an upper limit to the printable number of sheets.

FIG. 6 is a flowchart illustrating the operations of the printing system illustrated in FIG. 1.

FIG. 7 is a diagram illustrating another exemplary screen for notifying the user of the result of the determination whether the print condition for the second printer infringes on the restriction on the first printer.

FIG. 8 is a diagram illustrating still another exemplary screen for notifying the user of the result of the determination whether the print condition for the second printer infringes on the restriction on the first printer.

FIG. 9 is another exemplary table for managing the upper limit to the printable number of sheets.

FIG. 10 is a diagram illustrating yet another exemplary screen for notifying the user of the result of the determination whether the print condition for the second printer infringes on the restriction on the first printer; and

FIG. 11 is a flowchart illustrating another operations of the printing system illustrated in FIG. 1.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, exemplary embodiments of the present invention will be described with reference to the drawings.

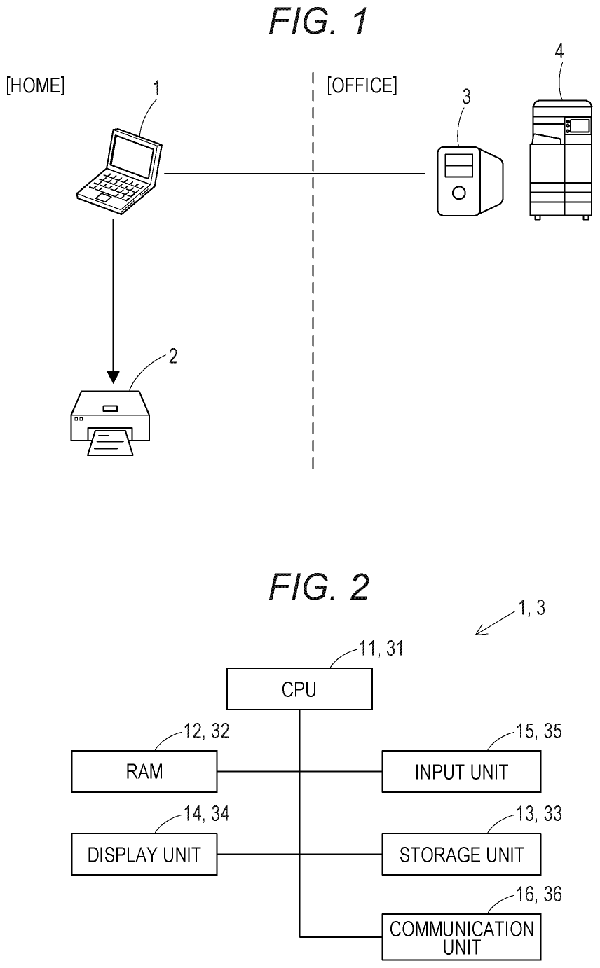

FIG. 1 is a diagram illustrating a configuration of a printing system according to an exemplary embodiment of the present invention. The printing system includes a device to be used in a home by a user who works from home and a device placed in an office.

In the home, a terminal apparatus 1 and a printer 2 (corresponding to a second printer) are placed. In the office, an MFP management system 3 and a printer 4 (corresponding to a first printer) including one or more MFPs are placed. In the following description, the printer 2 is also referred to as a “home printer”, and the printer 4 is also referred to as an “office printer”.

FIG. 2 is a block diagram illustrating a configuration of the terminal apparatus 1. The terminal apparatus 1 is practicable using an information processing apparatus such as a PC. The terminal apparatus 1 includes a central processing unit (CPU) 11, a random access memory (RAM) 12, a storage unit 13, a display unit 14, an input unit 15, a communication unit 16, and the like. In this exemplary embodiment, the terminal apparatus 1 may be a company-owned PC.

The CPU 11 controls the entire terminal apparatus 1 in a centralized manner, based on an operating system (OS), a printer driver, and other various applications. Details of the control will be described later. The printer driver refers to software that causes the CPU 11 to execute processing concerning printing between the home printer 2 and the MFP management system 3.

The RAM 12 is a memory that provides a workspace when the CPU 11 executes an operating program.

The storage unit 13 is a memory that stores an OS, a printer driver, various applications, and other kinds of data.

The display unit 14 displays various screens and messages, such as an operation screen for a user, documents, and images to be printed, and information (to be described later) transmitted from the MFP management system 3. The display unit 14 is practicable using a display device such as a liquid crystal display.

The input unit 15 includes a mouse, a touch panel, and the like for use in user's operations.

The communication unit 16 functions as a communication interface for communicating with the home printer 2 and the MFP management system 3.

The foregoing printer driver is installed in the terminal apparatus 1. The printer driver issues an instruction that enables printing using the home printer 2. Specifically, the user opens a print target file from various applications, such as a document creation application, on a screen of the terminal apparatus 1. The user then makes print settings, such as a sheet size, single-sided printing or double-sided printing, and color printing or monochrome printing, using the printer driver. The printer driver then issues a print instruction.

The home printer 2 is, for example, a printer of a user who works from home. The home printer 2 is capable of communicating with the terminal apparatus 1 in a wired or wireless manner.

The MFP management system 3 placed in the office manages the usage of the office printer 4. The MFP management system 3 implements management of an upper limit to the printable number of sheets (upper limit management), a restriction as to a function (function restriction), and the like on a user or group basis. The upper limit management refers to management of the printable number of sheets for each user or group in a certain period and prohibits execution of a print job for producing printouts exceeding the upper limit. The function restriction refers to management of a print function usable for each user and prohibits execution of a print job using a function which is not permitted. Examples of the function restriction include, but not limited to, prohibition of color printing, prohibition of single-sided printing, and prohibition of unity magnification printing.

The MFP management system 3 may be incorporated in the office printer 4. The MFP management system 3 may alternatively be practicable using a server in order to collectively manage a plurality of office printers 4. The MFP management system 3 may alternatively be placed outside the office. In this exemplary embodiment, the terminal apparatus 1 and the MFP management system 3 are connected via a network such as the Internet.

In a case where the MFP management system 3 is a server, the MFP management system 3 includes a CPU 31, a RAM 32, a storage unit 33, a display unit 34, an input unit 35, a communication interface 36, and the like as in the terminal apparatus 1 illustrated in FIG. 2. These units are basically similar in function to those of the terminal apparatus 1 except for a kind of data stored in the storage unit 33. The storage unit 33 stores, in addition to software such as an OS, information about restrictions as to an upper limit to the printable number of sheets, functions, and the like for each user or group. The storage unit 33 also stores, for example, a count value of the number of printed sheets to be managed for each user or group.

### First Exemplary Embodiment

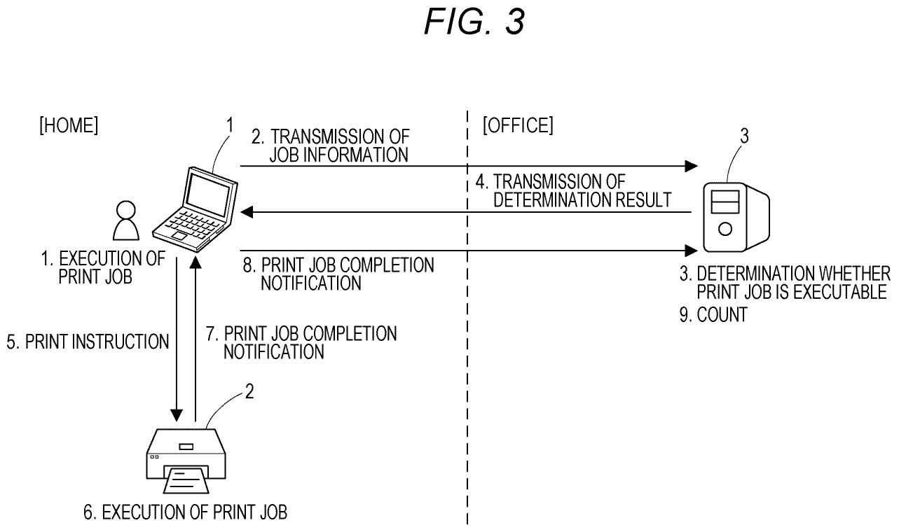

With reference to a sequence diagram of FIG. 3, the following will describe operations of the printing system illustrated in FIG. 1.

### 1. Execution of Print Job

The user makes print settings using the printer driver in the terminal apparatus 1 placed in the home and causes the home printer 2 to execute a print job. The print job includes information indicating that this print job is for business use, and user information.

### 2. Transmission of Job Information

In a case where the print job is for business use, the printer driver extracts “necessary information” from job information and transmits the “necessary information” to the MFP management system 3. The “necessary information” refers to information on a print condition required for a determination whether the print job infringes on the restrictions, such as the upper limit management and the function restriction, managed by the MFP management system 3. The “necessary information” includes, for example, the user identification information, the print settings, and the number of source documents (page count). In this case, a file body (image) to be printed is not transmitted.

### 3. Determination Whether Print Job is Executable

The MFP management system 3 analyzes the received information on the print condition. The MFP management system 3 also determines whether the print job is a job executable for the user (i.e., whether the number of printed sheets is countable), based on whether the print condition infringes on the restrictions. The MFP management system 3 reads the restrictions from the storage unit 33 to acquire the restrictions. Specifically, the MFP management system 3 determines whether the print job is executable, based on, for example, whether the number of printed sheets has already reached an upper limit applied to the user or whether the print job is executed using a prohibited function.

### 4. Transmission of Determination Result

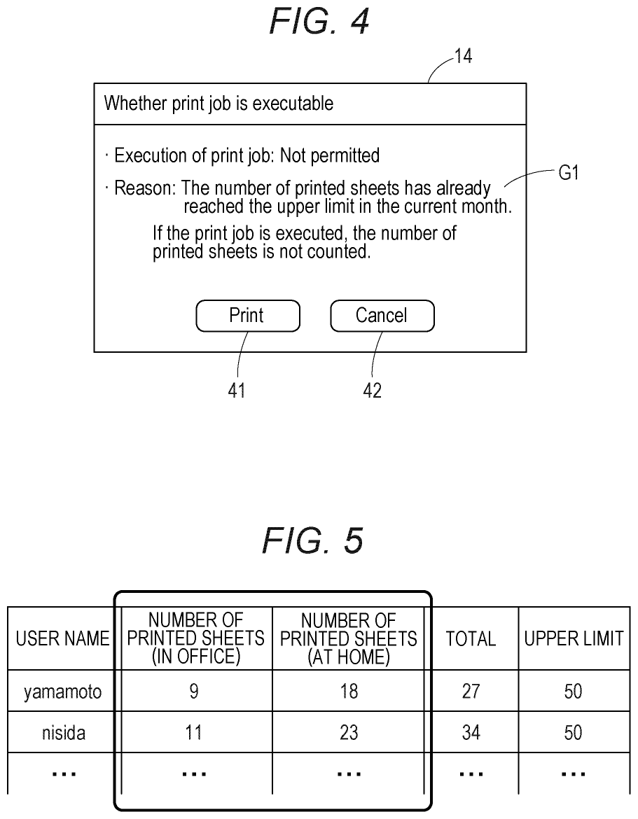

The MFP management system 3 transmits to the terminal apparatus 1 a result of the determination made in “3. Determination whether print job is executable” described above. The printer driver in the terminal apparatus 1 notifies the user of the determination result transmitted from the MFP management system 3, by displaying the determination result on the display unit 14. FIG. 4 illustrates an exemplary screen G1 showing the notification of the determination result. FIG. 4 illustrates an example in which the print job is not executable since the number of printed sheets in the current month has already reached the upper limit permitted to the user.

The MFP management system 3 determines that the print job is not executable since the number of printed sheets has already reached the upper limit. The printer driver in the terminal apparatus 1 notifies the user of a message indicating that the execution of the print job is not permitted, a reason therefor (i.e., the number of printed sheets in the current month has already reached the upper limit), and a result to be caused if the print job is executed (i.e., the number of printed sheets is uncountable), by displaying these kinds of information, together with a “Print” button 41 and a “Cancel” button 42, on the screen G1. The user determines whether to execute the print job on the notified condition, as will be described later.

In a case where the execution of the print job is permitted, a message indicating that the execution of the print job is permitted, and a result to be caused if the print job is executed (i.e., the number of printed sheets is counted) are displayed together with the “Print” button 41 and the “Cancel” button 42.

In a case where the execution of the print job is not permitted, a countermeasure may be notified in addition to or in place of the reason why the execution of the print job is not permitted. For example, in a case where prohibition of color printing or prohibition of single-sided printing is set, the printer driver may display, on the display unit 14, a message indicating that the execution of the print job is permitted, and the number of printed sheets is counted by changing color printing to monochrome printing. Alternatively, the printer driver may display, on the display unit 14, a message indicating that the execution of the print job is permitted, and the number of printed sheets is counted by changing single-sided printing to double-sided printing. In this case, the user is able to make print settings again so as not to infringe on the restrictions. In response to the print settings made again, the MFP management system 3 transmits a result of a determination “permitted”.

### 5. Print Instruction

The user confirms the result of the determination whether the print job is executable, displayed on the screen G1 of the display unit 14, and determines whether to execute the print job. In the case where the user intends to execute the print job, the user presses the “Print” button 41. In the case where the user does not intend to execute the print job, the user presses the “Cancel” button 42. In response to the press of the “Print” button 41, the printer driver issues a print instruction to the home printer 2.

### 6. Execution of Print Job

The home printer 2 executes the print job in accordance with the print instruction.

### 7 & 8. Print Job Completion Notification

After completion of the print job, the home printer 2 provides a print job completion notification to the printer driver in the terminal apparatus 1. The printer driver receives the print job completion notification from the home printer 2. The printer driver issues a print job completion notification to the MFP management system 3 only in a case where the printer driver has received the result of the determination “permitted” made by the MFP management system 3 as to the print job in “4. Transmission of determination result” described above. The print job completion notification also serves as an instruction to count the number of printed sheets.

### 9. Count

In response to the print job completion notification, the MFP management system 3 counts the number of printed sheets for the user. The user is able to settle the cost of counted sheets printed using the home printer 2. Desirably, the MFP management system 3 separately counts the number of sheets printed using the office printer 4 and the number of sheets printed using the home printer 2 to separately manage the upper limit to the number of sheets printed using the office printer 4 and the upper limit to the number of sheets printed using the home printer 2. The management in a separate manner facilitates charge and settlement of the cost of printing using the home printer 2.

FIG. 5 illustrates exemplary management of the upper limit to the number of printed sheets in the MFP management system 3. In this example, as indicated by a bold frame, the MFP management system 3 counts the number of sheets printed using the office printer 4 and the number of sheets printed using the home printer 2 separately to manage the total number of printed sheets and the upper limit to the total number of printed sheets for each user.

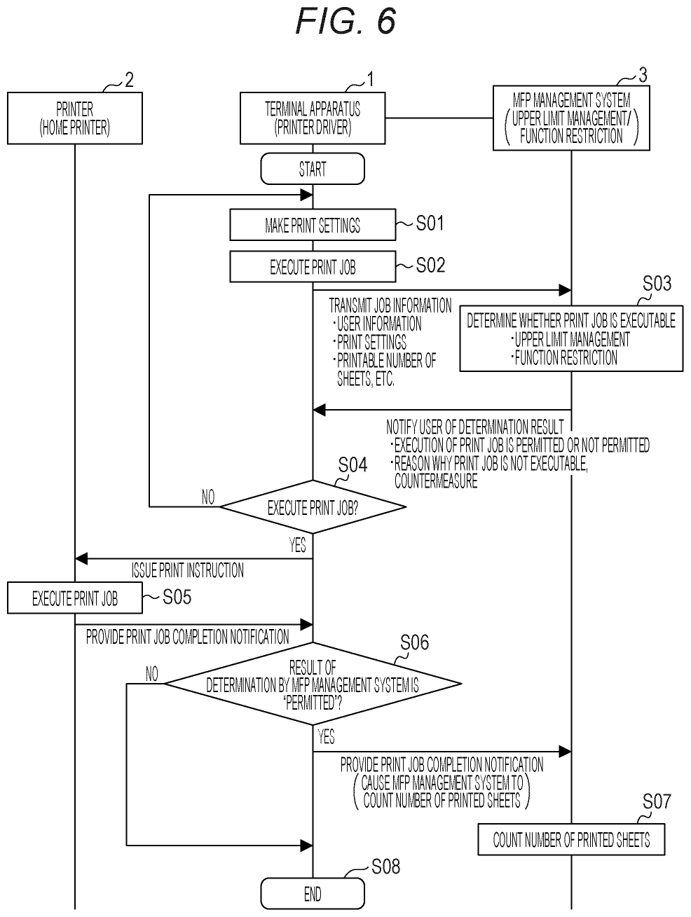

FIG. 6 is a flowchart illustrating the foregoing operations of the printing system.

In step S01, the printer driver in the terminal apparatus 1 makes print settings based on a user's operation. In step S02, next, the printer driver causes the home printer 2 to execute a print job based on the user's operation.

Next, the printer driver transmits job information to the MFP management system 3. The job information includes user information, the print settings, and a print condition such as the printable number of sheets. In step S03, next, the MFP management system 3, which has received the job information, compares the print condition in the job information with a restriction to determine whether the print job is executable, and then transmits a determination result to the terminal apparatus 1. The determination result includes information indicating that the execution of the print job is permitted or not permitted, a reason in a case where the print condition infringes on the restriction (i.e., a reason in a case where the execution of the print job is not permitted), a countermeasure in the case where the print condition infringes on the restriction, and the like.

The printer driver in the terminal apparatus 1, which has received the determination result from the MFP management system 3, notifies the user of the determination result by displaying the determination result on the display unit 14. In step S4, next, the printer driver determines whether the print job is executed based on the user's operation. In a case where the print job is not executed, that is, in a case where the user presses the “Cancel” button 42 (NO in step S4), the processing returns to step S01. In step S01, the printer driver makes print settings again. Alternatively, the printer driver may stop the print job. In a case where the print job is executed, that is, in a case where the user presses the “Print” button 41 (YES in step S4), the printer driver issues a print instruction to the home printer 2.

In step S05, the home printer 2 executes the print job based on the print instruction. After completion of the print job, the home printer 2 provides a print job completion notification to the terminal apparatus 1. In step S06, the printer driver in the terminal apparatus 1, which has received the print job completion notification, determines as to the print job whether the result of the determination by the MFP management system 3 is “permitted”. In a case where the determination result is “permitted” (YES in step S06), the printer driver provides a print job completion notification to the MFP management system 3 and causes the MFP management system 3 to count the number of printed sheets. In step S07, the MFP management system 3, which has received the print job completion notification, counts the number of printed sheets for the user.

In a case where the determination result is “not permitted” (NO in step S06), the processing ends. In this case, the MFP management system 3 does not count the number of printed sheets, so that the user bears the cost of printing using the home printer 2.

According to this exemplary embodiment, as described above, the MFP management system 3 acquires a restriction to be applied in a case where the user uses the office printer 4, and also acquires a print condition in a case where the user uses the home printer 2. The MFP management system 3 then determines whether the print condition infringes on the restriction, and the printer driver in the terminal apparatus 1 notifies the user of a determination result by displaying the determination result on the screen of the display unit 14. Therefore, the user is able to recognize whether the print condition set for the home printer 2 to be used by the user infringes on the restriction applied in a case where the user uses the office printer 4. Therefore, the user is able to execute the print job unless the print condition infringes on the restriction. In a case where the print condition infringes on the restriction, the user is able to take countermeasures. For example, the user is able to cancel the print job so as to avoid printing by his/her own expenses or is able to change the print condition so as not to infringe on the restriction.

### Second Exemplary Embodiment

The following will describe another exemplary embodiment of the present invention. According to this exemplary embodiment, even when a print job is not executable (since a print condition set for the print job infringes on a restriction) as a result of a determination by the MFP management system 3 as to whether the print job is executable in the first exemplary embodiment, the user can receive a notification that the MFP management system 3 is capable of counting the number of printed sheets as long as the print job is executed on a specific condition. The user is able to select whether to execute the print job. It should be noted that the specific condition is set in advance.

When the user selects to execute the print job, the MFP management system 3 counts the number of printed sheets in accordance with the specific condition.

Specifically, single-sided printing is prohibited, and only double-sided printing is permitted in an office for the purpose of paper saving in some cases. In other words, prohibition of single-sided printing is set as a restriction. In a case where the home printer 2 performs single-sided printing since it has no double-printing function, the MFP management system 3 determines that the print job is not executable since the print condition includes the prohibited setting (single-sided printing).

However, the user receives a notification that the number of sheets printed on the assumption that double-printing is performed as in the office (i.e., in accordance with the restriction) is counted by the MFP management system 3 (i.e., the company bears the cost of printing) and the user bears the cost of printing corresponding to the remaining number of printed sheets. The user selects whether to execute the print job.

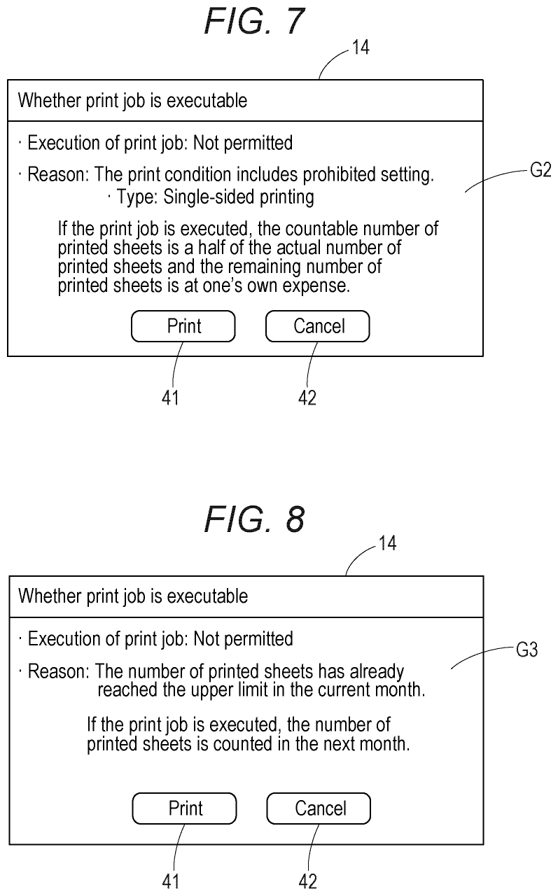

FIG. 7 illustrates a screen G2 displayed on the display unit 14 of the terminal apparatus 1 in this case, and the screen G2 shows a notification to be provided to the user. The screen G2 shows, in addition to the “Print” button 41 and the “Cancel” button 42, a message indicating that the execution of the print job is not permitted, a reason therefor (i.e., the print condition includes prohibited single-sided printing), and a result to be caused if the print job is executed (i.e., the countable number of printed sheets is a half of the actual number of printed sheets and the user bears the cost of printing corresponding to the remaining number of printed sheets).

When the user presses the “Print” button 41 to select to execute the print job, the home printer 2 executes the print job and then provides a print job completion notification to the terminal apparatus 1. The printer driver in the terminal apparatus 1 then provides a print job completion notification to the MFP management system 3. The MFP management system 3 counts the number of printed sheets corresponding to a half of the actual number of printed sheets.

As another example, in a case where the execution of the print job is not permitted since the printable number of sheets in the current month has already reached the upper limit, the user receives a notification that the print job is executable on a condition that the number of printed sheets is counted as the number of printable sheets in the next month.

FIG. 8 illustrates a screen G3 displayed on the display unit 14 of the terminal apparatus 1 in this case, and the screen G3 shows a notification to be provided to the user. The screen G3 shows, in addition to the “Print” button 41 and the “Cancel” button 42, a message indicating that the execution of the print job is not permitted, a reason therefor (i.e., the number of printed sheets in the current month has already reached the upper limit), and a result to be caused if the print job is executed (i.e., the number of printed sheets is counted in the next month).

When the user presses the “Print” button 41 to select to execute the print job, the home printer 2 executes the print job and then provides a print job completion notification to the terminal apparatus 1. The printer driver in the terminal apparatus 1 then provides a print job completion notification to the MFP management system 3. The MFP management system 3 counts the number of printed sheets as the number of printed sheets in the next month.

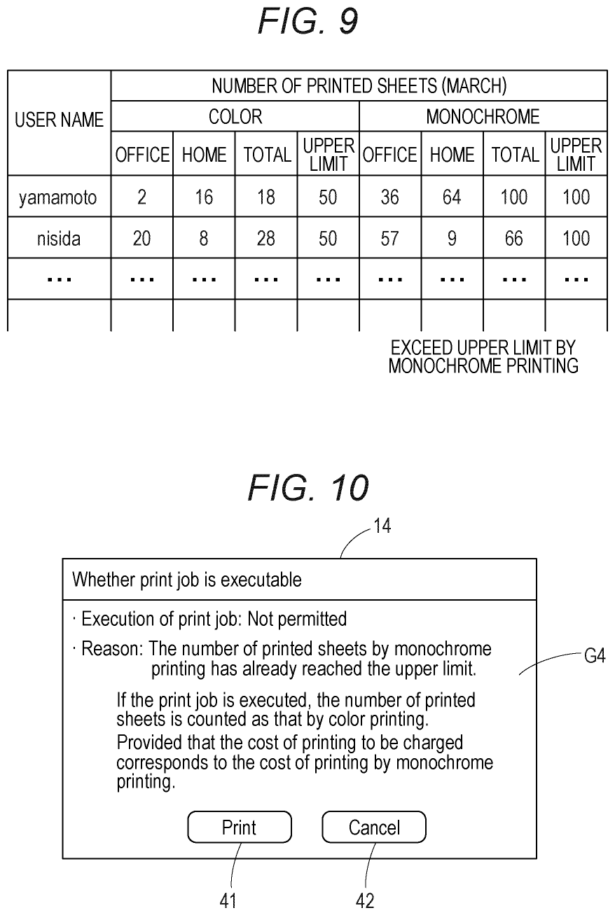

As still another example, as illustrated in FIG. 9, the MFP management system 3 separately manages an upper limit to the printable number of sheets by color printing and an upper limit to the printable number of sheets by monochrome printing. For example, the upper limit to the printable number of sheets is set at 100 for the user. In this case, if the counted number of printed sheets has already reached the upper limit, the MFP management system 3 determines that the execution of the print job is not permitted, even though the home printer 2 is capable of performing only monochrome printing.

As a result, the user receives a notification that the print job is executable on a condition that the number of printed sheets is countable as color printing. FIG. 10 illustrates a screen G4 displayed on the display unit 14 of the terminal apparatus 1 in this case, and the screen G4 shows a notification to be provided to the user. The screen G4 shows, in addition to the “Print” button 41 and the “Cancel” button 42, a message indicating that the execution of the print job is not permitted, a reason therefor (i.e., the number of printed sheets by monochrome printing has already reached the upper limit), and a result to be caused if the print job is executed (i.e., the number of printed sheets is counted as that by color printing; however, the cost of printing to be charged corresponds to that cost of printing by monochrome printing).

When the user presses the “Print” button 41 to select to execute the print job, the home printer 2 executes the print job and then provides a print job completion notification to the terminal apparatus 1. The printer driver in the terminal apparatus 1 then provides a print job completion notification to the MFP management system 3. The MFP management system 3 counts the number of printed sheets as the number of printed sheets by color printing.

As described above, since the count of the number of printed sheets on the specific condition is permitted, the cost of printing using the home printer 2 can be partially settled, which brings a significant advantage for the user.

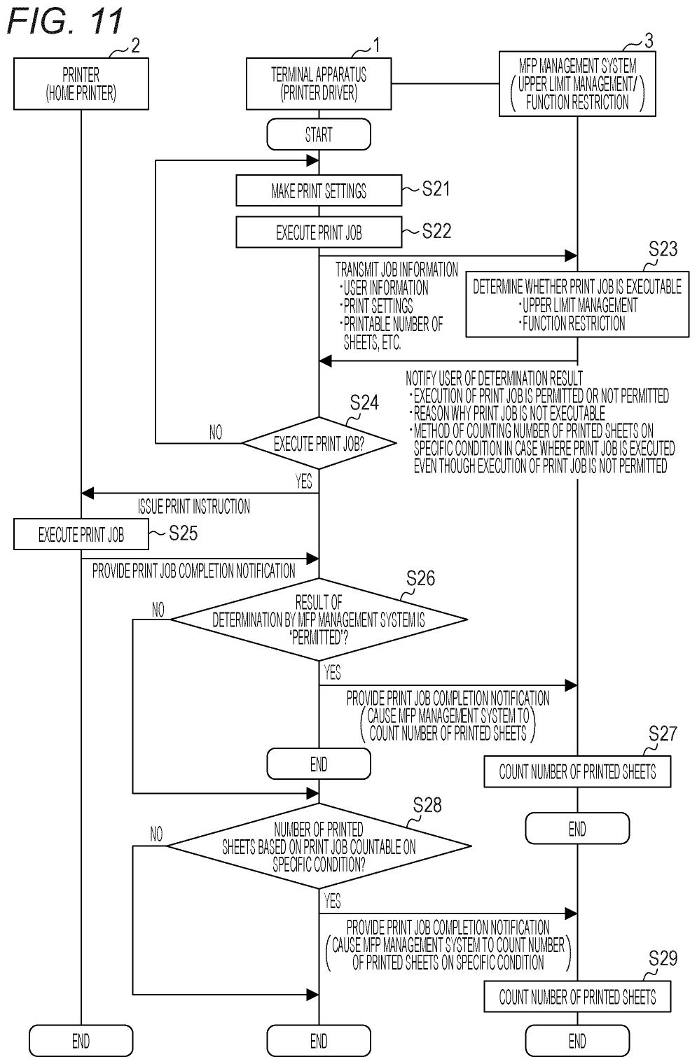

FIG. 11 is a flowchart illustrating the foregoing operations of the printing system according to the second exemplary embodiment.

In step S21, the printer driver in the terminal apparatus 1 makes print settings based on a user's operation. In step S22, next, the printer driver causes the home printer 2 to execute a print job based on the user's operation.

Next, the printer driver transmits job information to the MFP management system 3. The job information includes user information, the print settings, and a print condition such as the printable number of sheets. In step S23, next, the MFP management system 3, which has received the job information, compares the print condition in the job information with a restriction to determine whether the print job is executable, and then transmits a determination result to the terminal apparatus 1. The determination result includes information indicating that the execution of the print job is permitted or not permitted, a reason in a case where the print condition infringes on the restriction (i.e., a reason in a case where the execution of the print job is not permitted), and a method of counting the number of printed sheets on a specific condition in a case where the print job is executed even though the print condition infringes on the restriction.

The printer driver in the terminal apparatus 1, which has received the determination result from the MFP management system 3, notifies the user of the determination result by displaying the determination result on the display unit 14. In step S24, next, the printer driver determines whether the print job is executed based on the user's operation. In a case where the print job is not executed, that is, in a case where the user presses the “Cancel” button 42 (NO in step S24), the processing returns to step S21. In step S21, the printer driver makes print settings again. In a case where the print job is executed, that is, in a case where the user presses the “Print” button 41 (YES in step S24), the printer driver issues a print instruction to the home printer 2.

In step S25, the home printer 2 executes the print job based on the print instruction. After completion of the print job, the home printer 2 provides a print job completion notification to the terminal apparatus 1. In step S26, the printer driver in the terminal apparatus 1, which has received the print job completion notification, determines as to the print job whether the result of the determination by the MFP management system 3 is “permitted”. In a case where the determination result is “permitted” (YES in step S26), the printer driver provides a print job completion notification to the MFP management system 3 and causes the MFP management system 3 to count the number of printed sheets. In step S27, the MFP management system 3, which has received the print job completion notification, counts the number of printed sheets for the user.

In a case where the determination result is “not permitted” (NO in step S26), the processing proceeds to step S28. In step S28, the printer driver determines whether the number of printed sheets based on the print job is countable on the specific condition. In a case where the number of printed sheets based on the print job is countable on the specific condition (YES in step S28), the printer driver provides a print job completion notification to the MFP management system 3 and causes the MFP management system 3 to count the number of printed sheets on the specific condition. In step S29, the MFP management system 3, which has received the print job completion notification, counts the number of printed sheets for the user on the specific condition.

In a case where the number of printed sheets based on the print job is not countable on the specific condition (NO in step S28), the processing ends.

### Third Exemplary Embodiment

In the first and second exemplary embodiments, the MFP management system 3 determines whether the print condition for the home printer infringes on the restriction. According to a third exemplary embodiment, the printer driver in the terminal apparatus 1 makes the determination. A printing system according to the third exemplary embodiment is equal in device configuration to the printing system illustrated in FIG. 1.

The terminal apparatus 1 acquires information on restrictions as to an upper limit to the printable number of sheets, functions, and the like stored in the MFP management system 3. The printer driver in the terminal apparatus 1 has only to compare the acquired restrictions with a print condition set for a print job to be executed using the home printer 2 and to determine whether the print condition infringes on the restrictions, that is, whether the number of printed sheets is countable. Furthermore, the printer driver in the terminal apparatus 1 has only to notify the user of a determination result, by displaying the determination result on the display unit 14. In a case where the print condition infringes on the restrictions, the printer driver in the terminal apparatus 1 notifies the user of at least one of a reason for the infringement or a countermeasure against the infringement in addition to the determination result or notifies the user of information indicating that the number of printed sheets is countable on a specific condition, as in the first and second exemplary embodiments.

In a case where the user executes the print job, when the print condition does not infringe on the restrictions or when the number of printed sheets is countable on the specific condition, the printer driver in the terminal apparatus 1 transmits and provides the print condition and a print job completion notification to the MFP management system 3. The MFP management system 3 is thus capable of confirming whether the number of printed sheets is countable and correctly counting the number of printed sheets.

Hereinabove, an exemplary embodiment of the present invention has been described; however, the present invention is not limited to the foregoing exemplary embodiment. For example, the terminal apparatus 1 notifies the user of the result of the determination by the MFP management system 3 as to whether the print job is executable, by displaying the determination result on the screen of the display unit 14. Alternatively, the determination result may be notified in such a manner that the MFP management system 3 sends the determination result by e-mail to a user's mail address.

In addition, the MFP management system 3 manages the upper limit to the printable number of sheets for each user or group. Alternatively, the terminal apparatus 1 and the MFP management system 3 may share management data on the upper limit to the printable number of sheets as to only the relevant user such that the terminal apparatus 1 implements the management together with the management by the MFP management system 3.

Although one or more embodiments of the present invention have been described and illustrated in detail, the disclosed embodiments are made for purposes of illustration and example only and not limitation. The scope of the present invention should be interpreted by terms of the appended claims.

What is claimed is:

1. A printing system comprising
a hardware processor that:
acquires a restriction to be applied in a case where a user uses a first printer;
acquires a print condition in a case where the user uses a second printer;
determines whether the print condition infringes on the restriction; and
notifies the user of a determination result.

2. The printing system according to claim 1, wherein
the hardware processor, when determining that the print condition infringes on the restriction, notifies the user of at least one of a reason for the infringement or a countermeasure against the infringement together with a determination result.

3. The printing system according to claim 1, wherein
the hardware processor, when determining that the print condition does not infringe on the restriction, provides an instruction to count a number of printed sheets for the user, in response to completion of printing using the second printer on the print condition.

4. The printing system according to claim 1, wherein
the hardware processor, when determining that the print condition infringes on the restriction, provides an instruction not to count a number of printed sheets for the user as to printing using the second printer on the print condition.

5. The printing system according to claim 3, wherein
the restriction comprises a restriction as to a printable number of sheets for the user.

6. The printing system according to claim 3, wherein
the restriction comprises a restriction as to a print function usable by the user.

7. The printing system according to claim 1, wherein
the hardware processor separately manages count of a number of printed sheets using the first printer and count of a number of printed sheets using the second printer.

8. The printing system according to claim 1, wherein
the hardware processor, in a case where the print condition infringes on the restriction, but a number of printed sheets is countable on a specific condition, notifies the user of the specific condition together with the determination result.

9. The printing system according to claim 8, wherein
the hardware processor provides an instruction to count a number of printed sheets for the user on the specific condition, in response to completion of printing using the second printer on the print condition.

10. A printing method comprising:
acquiring a restriction to be applied in a case where a user uses a first printer;
acquiring a print condition in a case where the user uses a second printer;
determining whether the print condition infringes on the restriction; and
notifying the user of a determination result.

11. A non-transitory recording medium storing a computer readable program that causes a computer to execute:
acquiring a restriction to be applied in a case where a user uses a first printer;
acquiring a print condition in a case where the user uses a second printer;
determining whether the print condition infringes on the restriction; and
notifying the user of a determination result.

12. The non-transitory recording medium according to claim 11, wherein
the computer readable program causes the computer to execute, when determining that the print condition infringes on the restriction, notifying the user of at least one of a reason for the infringement or a countermeasure against the infringement together with a determination result.

13. The non-transitory recording medium according to claim 11, wherein
the computer readable program causes the computer to execute, when determining that the print condition does not infringe on the restriction, providing an instruction to count a number of printed sheets for the user, in response to completion of printing using the second printer on the print condition.

14. The non-transitory recording medium according to claim 11, wherein
the computer readable program causes the computer to execute, when determining that the print condition infringes on the restriction, providing an instruction not to count a number of printed sheets for the user as to printing using the second printer on the print condition.

15. The non-transitory recording medium according to claim 13, wherein
the restriction comprises a restriction as to a printable number of sheets for the user.

16. The non-transitory recording medium according to claim 13, wherein
the restriction comprises a restriction as to a print function usable by the user.

17. The non-transitory recording medium according to claim 11, wherein
the computer readable program causes the computer to execute separately managing count of a number of printed sheets using the first printer and count of a number of printed sheets using the second printer.

18. The non-transitory recording medium according to claim 11, wherein
the computer readable program causes the computer to execute, in a case where the print condition infringes on the restriction, but a number of printed sheets is countable on a specific condition, notifying the user of the specific condition together with the determination result.

19. The non-transitory recording medium according to claim 18, wherein
the computer readable program causes the computer to execute providing an instruction to count a number of printed sheets for the user on the specific condition, in response to completion of printing using the second printer on the print condition.
